(19) United States
(12) Patent Application Publication
(10) Pub. No.: US 2025/0298356 A1
(43) Pub. Date: Sep. 25, 2025

(54) IMAGE FORMING SYSTEM

(71) Applicant: FUJIFILM Business Innovation Corp., Tokyo (JP)

(72) Inventor: Hidefumi NISHIGAI, Kanagawa (JP)

(73) Assignee: FUJIFILM Business Innovation Corp., Tokyo (JP)

(21) Appl. No.: 18/776,638

(22) Filed: Jul. 18, 2024

(30) Foreign Application Priority Data
Mar. 25, 2024 (JP) 2024-048592

(51) Int. Cl. G03G 15/00; G03G 15/01

(52) U.S. Cl. CPC G03G 15/5029; G03G 15/0189

(57) ABSTRACT

An image forming system includes: an intermediate transfer body that is used for forming a toner image on a surface of the intermediate transfer body and for transferring the toner image to a recording medium; a white toner image former that is able to form a white toner image on the surface of the intermediate transfer body; a silver toner image former that is disposed farther on a downstream side than the white toner image former and that is able to form a silver toner image on the surface of the intermediate transfer body; and a processor configured to perform control to superimpose a silver toner image on a white toner image layer of a white toner image formed on the surface of the intermediate transfer body when a color of the recording medium is a predetermined color.

### CROSS-REFERENCE TO RELATED APPLICATIONS

This application is based on and claims priority under 35 USC 119 from Japanese Patent Application No. 2024-048592 filed Mar. 25, 2024.

### BACKGROUND

### (i) Technical Field

The present disclosure relates to an image forming system.

### (ii) Related Art

Japanese Unexamined Patent Application Publication No. 2018-45225 discloses an electrostatic charge image developing toner. The electrostatic charge image developing toner includes acicular titanium oxide having an average aspect ratio of 3 to 30 as a white pigment.

Japanese Unexamined Patent Application Publication No. 2018-40910 discloses an image forming apparatus including an image forming unit. The image forming unit forms a flat pigment toner image with a flat pigment toner containing a flat pigment, a white toner image with a white toner, and a color toner image with a color toner other than the flat pigment toner and the white toner. The image forming apparatus has the following mode. Underlying layers are formed at least in an image forming region of a recording medium in order of a first underlying layer constituted by the white toner and a second underlying layer constituted by the flat pigment toner in a viewing direction.

Japanese Unexamined Patent Application Publication No. 2020-52094 discloses the following image forming apparatus. The image forming apparatus includes first and second forming units and first and second transfer units. The first forming unit forms a superimposed toner image constituted by yellow, magenta, and cyan toner images superimposed on each other in a first intermediate transfer unit. The second forming unit is disposed farther on the downstream side of a transport direction of a recording medium than the first forming unit. The second forming unit forms a black toner image in a second intermediate transfer unit. The first transfer unit transfers the superimposed toner image formed in the first intermediate transfer unit by the first forming unit to the recording medium. The second transfer unit is disposed farther on the downstream side of the transport direction of the recording medium than the first transfer unit. The second transfer unit superimposes and transfers the black toner image formed in the second intermediate transfer unit by the second forming unit onto the superimposed toner image formed on the recording medium.

### SUMMARY

Aspects of non-limiting embodiments of the present disclosure relate to aiming at improving the opacity of a color of a recording medium in a configuration in which a toner image formed on an intermediate transfer body is transferred to a recording medium, compared with the configuration in which, when the color of a recording medium is a predetermined color, only a white toner image is superimposed multiple times on the surface of the intermediate transfer body.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including: an intermediate transfer body that is used for forming a toner image on a surface of the intermediate transfer body and for transferring the toner image to a recording medium; a white toner image former that is able to form a white toner image on the surface of the intermediate transfer body; a silver toner image former that is disposed farther on a downstream side than the white toner image former and that is able to form a silver toner image on the surface of the intermediate transfer body; and a processor configured to perform control to superimpose a silver toner image on a white toner image layer of a white toner image formed on the surface of the intermediate transfer body when a color of the recording medium is a predetermined color.

### BRIEF DESCRIPTION OF THE DRAWINGS

Exemplary embodiments of the present disclosure will be described in detail based on the following figures, wherein:

FIG. 1 is a schematic view of an image forming device and a fixing device of an image forming apparatus according to an exemplary embodiment of the disclosure;

FIG. 2 is a block diagram illustrating the hardware configuration of an image forming apparatus according to an exemplary embodiment of the disclosure;

FIG. 3 is a schematic view of a color measuring unit, an image forming device, and a fixing device of an image forming apparatus according to an exemplary embodiment of the disclosure;

FIG. 4 is a flowchart illustrating processing for superimposing a silver toner image on a white toner image layer formed on the surface of an intermediate transfer body by using an image forming apparatus according to an exemplary embodiment of the disclosure;

FIG. 5 is a side sectional view of the intermediate transfer body in the image forming apparatus shown in FIG. 1 illustrating a state in which a white toner image is formed on the surface of the intermediate transfer body;

FIG. 6 is a side sectional view of the intermediate transfer body in the image forming apparatus shown in FIG. 1 illustrating a state in which a white toner image layer is formed by superimposing a white toner image on another white toner image formed on the surface of the intermediate transfer body;

FIG. 7 is a side sectional view of the intermediate transfer body in the image forming apparatus shown in FIG. 1 illustrating a state in which a silver toner image is superimposed on a white toner image layer formed on the surface of the intermediate transfer body;

FIG. 8 is a side sectional view of a recording medium in the image forming apparatus shown in FIG. 1 illustrating a state in which a toner image formed on the surface of the intermediate transfer body is transferred to the recording medium; and

FIG. 9 is a schematic view of a color measuring unit, an image forming device, and a fixing device of an image forming apparatus according to another exemplary embodiment of the disclosure.

### DETAILED DESCRIPTION

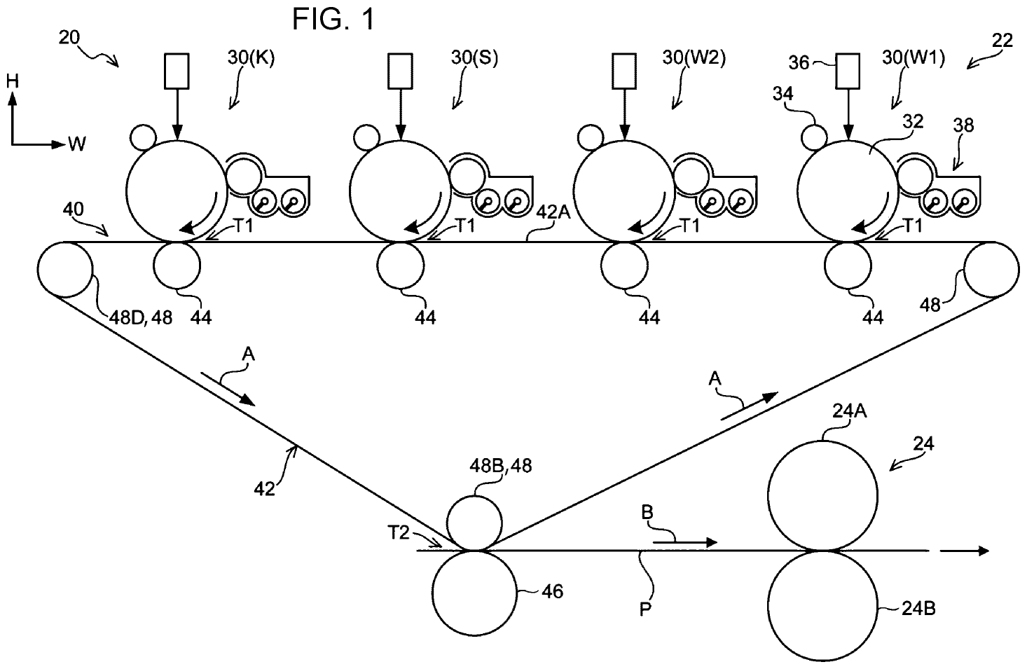

An image forming apparatus 20, which is an example of an image forming system according to an exemplary embodiment of the disclosure, will be described below with reference to FIGS. 1 through 8.

In the drawings, the arrow H indicates the up-down direction (more specifically, the vertical direction) of the image forming apparatus 20, the arrow W indicates the widthwise direction (more specifically, the horizontal direction) of the image forming apparatus 20, and the arrow D indicates the depth direction (more specifically, the horizontal direction) of the image forming apparatus 20. The up-down direction, the widthwise direction, and the depth direction of the image forming apparatus 20 intersect with (more specifically, perpendicular to) each other. The disclosure is not limited to this configuration, and the widthwise direction of the image forming apparatus 20 may be the depth direction of the image forming apparatus 20, and the depth direction of the image forming apparatus 20 may be the widthwise direction of the image forming apparatus 20.

In the drawings, elements designated by like reference numeral are the same or similar elements. In the following exemplary embodiments, the same explanation may not be repeated and the same reference signs may be omitted. The drawings used for explaining the exemplary embodiments are merely schematically illustrated, and the dimensional relationships between the elements and the ratio of the elements, for example, are not necessarily match those of actual elements. Among the drawings, the dimensional relationships between the elements and the ratio of the elements in one drawing are not necessarily match those in another drawing.

As illustrated in FIG. 1, the image forming apparatus 20 according to the exemplary embodiment is an apparatus that forms an image on a recording medium P. More specifically, the image forming apparatus 20 is an electrophotographic image forming apparatus that forms a toner image (an example of an image) on the recording medium P. In the exemplary embodiment, a sheet is used as an example of the recording medium P, but the recording medium P is not limited thereto.

The image forming apparatus 20 includes an image forming device 22 and a fixing device 24. The elements (image forming device 22 and fixing device 24) of the image forming apparatus 20 will be explained below.

### (Image Forming Device 22)

As shown in FIG. 1, the image forming device 22 has a function of forming a toner image on the recording medium P. The image forming device 22 includes plural image forming units 30 and a transfer unit 40.

The plural image forming units 30 are provided on a surface 42A of a transfer belt 42, which will be discussed later, so as to be spaced out from each other in the rotating direction A of the transfer belt 42. As an example, the image forming device 22 of the exemplary embodiment includes two image forming units 30 that form a white (W) toner image, one image forming unit 30 that forms a silver(S) toner image, and one image forming unit 30 that forms a black (K) toner image.

From the upstream side of the rotating direction A of the transfer belt 42, the white image forming units 30, silver image forming unit 30, and black image forming unit 30 are sequentially disposed. Between the two white image forming units 30, the image forming unit 30 positioned farther on the upstream side of the rotating direction A will be called an image forming unit 30(W1), while the other image forming unit 30 will be called an image forming unit 30(W2). Likewise, the silver image forming unit 30 will be called an image forming unit 30(S), and the black image forming unit 30 will be called an image forming unit 30(K).

The image forming unit 30(W1) and the image forming unit 30(W2) of the exemplary embodiment are an example of a white toner image former that can form a white toner image on the surface 42A of the transfer belt 42. The image forming unit 30(S) is an example of a silver toner image former that is disposed farther on the downstream side of the rotating direction A than the image forming unit 30(W1) and the image forming unit 30(W2) and that can form a silver toner image on the surface 42A of the transfer belt 42.

As shown in FIG. 1, the image forming units 30 are configured similarly to each other, except for a toner to be used. Hence, the elements only of the image forming unit 30(W1) are designated by reference numerals in FIG. 1 as a representative.

Each image forming unit 30 includes a photoconductor drum 32 that is rotated in one direction (clockwise in FIG. 1, for example). The photoconductor drum 32 is an example of an image carrier. Each image forming unit 30 also includes a charger 34, an exposure device 36, and a developing device 38.

In each image forming unit 30, the charger 34 charges the photoconductor drum 32. The exposure device 36 exposes the photoconductor drum 32 charged by the charger 34 to light so as to form an electrostatic latent image on the photoconductor drum 32. The developing device 38 develops the electrostatic latent image formed on the photoconductor drum 32 by the exposure device 36 so as to form a toner image.

The photoconductor drum 32 is rotated while holding the electrostatic latent image formed as described above on its peripheral surface so that the electrostatic latent image is moved to face the developing device 38.

As illustrated in FIG. 1, the transfer unit 40 has a function of transferring toner images formed in the image forming units 30 to the recording medium P. More specifically, the transfer unit 40 performs first transfer to transfer the toner images on the individual photoconductor drums 32 onto the transfer belt 42, which serves as an intermediate transfer body, by superimposing the toner images with each other and then performs second transfer to transfer the superimposed toner image to the recording medium P. As shown in FIG. 1, the transfer unit 40 includes the transfer belt 42, first transfer rollers 44, and a second transfer roller 46.

The first transfer roller 44 is a roller that transfers a toner image formed on the corresponding photoconductor drum 32 to the transfer belt 42 at a first transfer position T1 between the photoconductor drum 32 and the first transfer roller 44. In the exemplary embodiment, a first transfer electric field is applied to between the first transfer roller 44 and the photoconductor drum 32, thereby transferring the toner image formed on the photoconductor drum 32 to the transfer belt 42 at the first transfer position T1.

The toner image formed on each photoconductor drum 32 is transferred to the surface 42A, which is the outer peripheral surface, of the transfer belt 42. As shown in FIG. 1, the transfer belt 42 is a ring-like endless body and is wound on plural rollers 48 so as to determine its position.

Among the plural rollers 48, a drive roller 48D, for example, is driven and rotated by a drive force from a drive source (not shown), thereby rotating the transfer belt 42 in the direction indicated by the arrow A. Among the plural rollers 48, a roller 48B shown in FIG. 1 is an opposing roller 48B that opposes the second transfer roller 46.

The second transfer roller 46 is a roller that transfers a toner image transferred onto the transfer belt 42 to the recording medium P at a second transfer position T2 between the opposing roller 48B and the second transfer roller 46. In the exemplary embodiment, a second transfer electric field is applied to between the opposing roller 48B and the second transfer roller 46, thereby transferring the toner image on the transfer belt 42 to the recording medium P at the second transfer position T2.

### (Fixing Device 24)

As illustrated in FIG. 1, the fixing device 24 has a function of fixing a toner image transferred onto the recording medium P by the second transfer roller 46 to the recording medium P. The fixing device 24 includes a heating roller 24A, which is a heating member, and a pressurizing roller 24B, which is a pressurizing member. The fixing device 24 heats and pressurizes the recording medium P by using the heating roller 24A and the pressurizing roller 24B so as to fix the toner image formed on the recording medium P to the recording medium P.

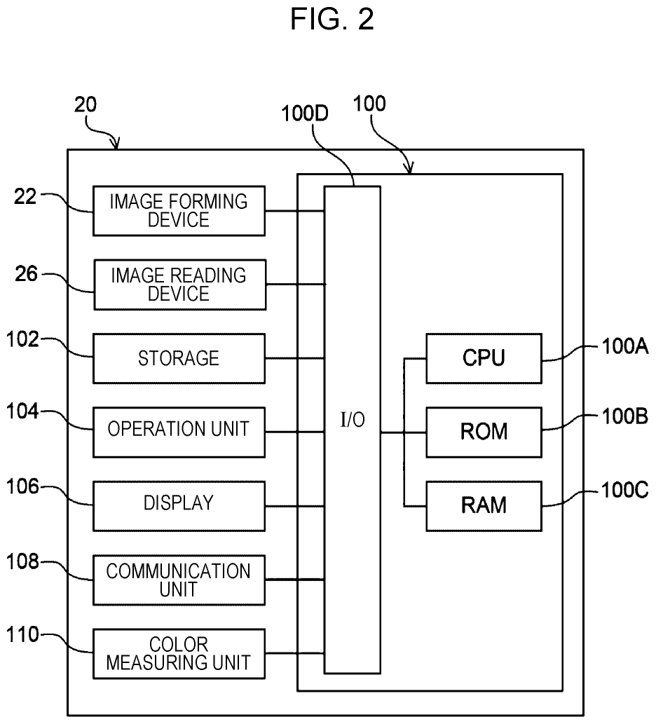

As illustrated in FIG. 2, the image forming apparatus 20 includes a processor 100, a storage 102, an operation unit 104, a display 106, a communication unit 108, a color measuring unit 110, the image forming device 22, and an image reading device 26, for example.

### (Processor 100)

The processor 100 includes a central processing unit (CPU) 100A, a read only memory (ROM) 100B, a random access memory (RAM) 100C, and an input/output interface (I/O) 100D. The processor 100 controls the entire operation of the image forming apparatus 20. For example, in the ROM 100B, various control programs and various parameters, for example, are stored. The RAM 100C is used as a work area, for example, for the CPU 100A to execute various programs.

In the storage 102, various programs and various items of data for executing printing processing and application programs, for example, are stored.

The operation unit 104 is used for inputting various pieces of information.

The display 106 is used for displaying various pieces of information.

The communication unit 108 is an interface for sending and receiving various items of data to and from external devices, such as a server. The communication unit 108 may be able to perform direction communication with devices by using near field communication (NFC), such as Wi-Fi (registered trademark) and Bluetooth (registered trademark).

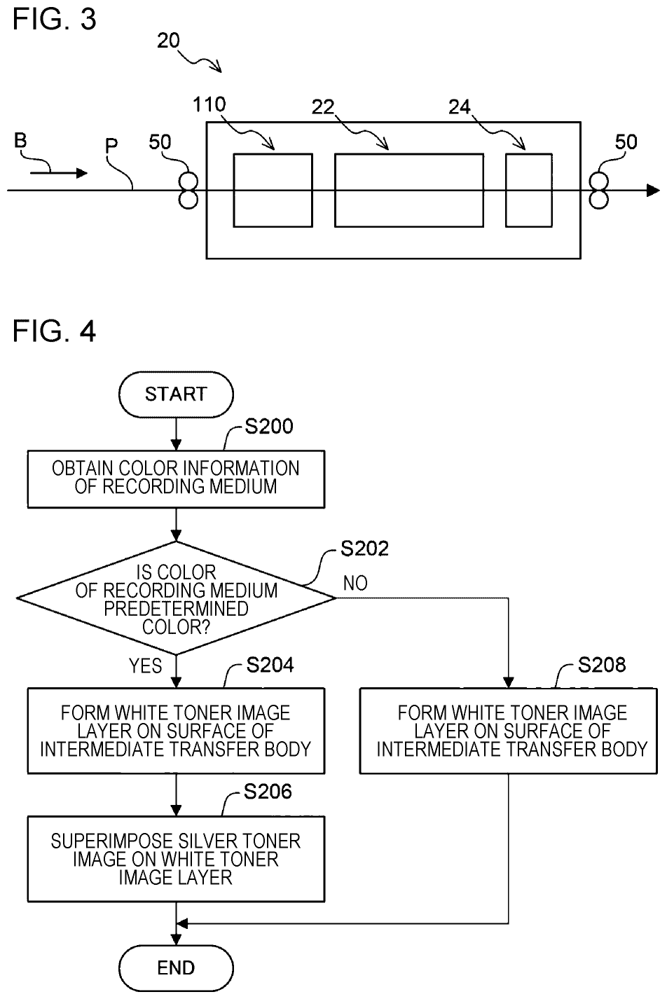

As illustrated in FIG. 3, the color measuring unit 110 is disposed farther on the upstream side of the transport direction B of the recording medium P than the image forming device 22. The color measuring unit 110 has a function of measuring the color of the recording medium P. For example, the color measuring unit 110 applies light beams of different wavelengths to the recording medium P and measures the color of the recording medium P based on the wavelength and the intensity of light reflected by the recording medium P. Information (color information) on the color of the recording medium P measured by the color measuring unit 110 is stored in the RAM 100C or the storage 102, for example. Color measurement is not limited to the above-described approach if the color of the recording medium P can be measured.

In FIG. 3, the image forming apparatus 20 is disposed on a transport path of the recording medium P between transport rollers 50. However, the disclosure is not restricted to this configuration. The image forming apparatus 20 may include a sheet feeder (not shown) and the transport rollers 50 may be disposed on a transport path from this sheet feeder to the image forming device 22. In this case, the color measuring unit 110 may be disposed between the sheet feeder and the image forming device 22.

The image reading device 26 has a function of reading an image of a document set in the image forming apparatus 20. As an example, the image forming apparatus 20 of the exemplary embodiment includes the image reading device 26. However, the disclosure is not limited to this configuration, and the provision of the image reading device 26 may be omitted.

As shown in FIG. 2, the elements of the image forming apparatus 20 are electrically connected to each other by a system bus.

The operation of the processor 100 will now be described below.

When the color of a recording medium P is a predetermined color, the processor 100 performs control to superimpose a silver toner image T(S) on a white toner image layer R(W) formed on the surface 42A of the transfer belt 42. This will be explained more specifically. The processor 100 obtains color information of a recording medium P on which an image is to be formed from the RAM 100C or the storage 102. Likewise, the processor 100 obtains predetermined color information from the ROM 100B, the RAM 100C, or the storage 102. If the color information of the recording medium P is found to be the same as the predetermined color information, the processor 100 performs control to superimpose the silver toner image T(S) on the white toner image layer R(W) formed on the surface 42A of the transfer belt 42.

When the color information of the recording medium P is predetermined first color information, the processor 100 performs control to form a white toner image T(W1) on the surface 42A of the transfer belt 42 and to superimpose a silver toner image T(S) on a layer R(W) of the white toner image T(W1). When the color information of the recording medium P is predetermined second color information, the processor 100 performs control to superimpose a white toner image T(W2) on the white toner image T(W1) formed on the surface 42A of the transfer belt 42 so as to form a white toner image layer R(W) and to superimpose the silver toner image T(S) on the white toner image layer R(W). That is, the processor 100 may perform control to form a white toner image layer R(W) of a single white toner image or multiple white toner images in accordance with the color information of the recording medium P. As the second color information, a color (red or green, for example) that is more likely to make the color of the recording medium P, which is a base, be seen through when a silver toner and a white toner are superimposed on the recording medium P than the color of the first color information is set.

The processor 100 may perform control to change the density of the white toner and that of the silver toner in accordance with the color of the recording medium P. More specifically, the processor 100 may perform control to change the density of the white toner and that of the silver toner in accordance with the color information of the recording medium P. For example, when the color information of the recording medium P is the first color information, the processor 100 may perform control to superimpose a silver toner image T(S) of a toner density of 10% to 40% on a layer R(W) of a white toner image of a toner density of 100%. When the color information of the recording medium P is the second color information, the processor 100 may perform control to superimpose multiple white toner images of a toner density of 100% on each other so as to form a white toner image layer R(W) and to superimpose a silver toner image T(S) of a toner image of 10% to 40% on the white toner image layer R(W).

Regardless of the color of the recording medium P, the processor 100 may perform control to superimpose multiple white toner images of a toner density of 100% on each other so as to form a white toner image layer R(W), to change the toner density of a silver toner image T(S) to a range of 10% to 40% in accordance with the color of the recording medium P, and then to superimpose the silver toner image T(S) on the white toner image layer R(W). If multiple white toner images are superimposed on each other, about two white toner images may be suitably superimposed so as not to make the resulting white toner image layer R(W) too thick.

“Toner density” is the ratio of the density assuming that the maximum value of toner that can be transferred onto the surface 42A of the transfer belt 42 with one transfer operation using one first transfer roller 44 after the toner is developed by one developing device 38 is 100%.

The processor 100 may convert the obtained color information of the recording medium P into values in a Lab color space, and when the lightness L* of the converted values in the Lab color space satisfies L*<50, the processor 100 may perform control to superimpose the silver toner image T(S) on the white toner image layer R(W).

The processor 100 may convert the obtained color information of the recording medium P into values in the Lab color space, and when the chromaticity b* of the converted values in the Lab color space satisfies 30>b*>−30, the processor 100 may perform control to superimpose the silver toner image T(S) on the white toner image layer R(W).

The processor 100 may convert the obtained color information of the recording medium P into values in the Lab color space, and when the chromaticity a* of the converted values in the Lab color space satisfies a*<−30 or a*>+30, the processor 100 may perform control to superimpose the silver toner image T(S) on the white toner image layer R(W).

In the exemplary embodiment, as an example, the processor 100 converts the obtained color information of the recording medium P into values in the Lab color space, and when, among the converted values in the Lab color space, the lightness L* satisfies L*<50, the chromaticity b* satisfies 30>b*>−30, and the chromaticity a* satisfies a*<−30 or a*>+30, the processor 100 performs control to superimpose the silver toner image T(S) on the white toner image layer R(W).

Processing for forming a white toner image layer R(W) on the surface 42A of the transfer belt 42 and for superimposing a silver toner image T(S) on the white toner image layer R(W) by using the image forming apparatus 20 of the exemplary embodiment will now be described below with reference to the flowchart of FIG. 4.

In step S200, when the image forming apparatus 20 forms a toner image to be transferred to the transfer belt 42, the processor 100 obtains color information of a recording medium P on which an image is to be formed.

Then, in step S202, the processor 100 obtains predetermined color information and compares it with the color information of the recording medium P. If the color information of the recording medium P is found to be the same as the predetermined color information, the processor 100 proceeds to step S204. If the color information of the recording medium P is not the same as the predetermined color information, the processor 100 proceeds to step S208. In step S208, the processor 100 performs control to form only a white toner image layer R(W) on the surface 42A of the transfer belt 42 and terminates the processing. In step S208, the processor 100 may perform control to superimpose multiple white toner images on each other to form a white toner image layer R(W) and also to change the toner density of the white toner image in accordance with the color information of the recording medium P.

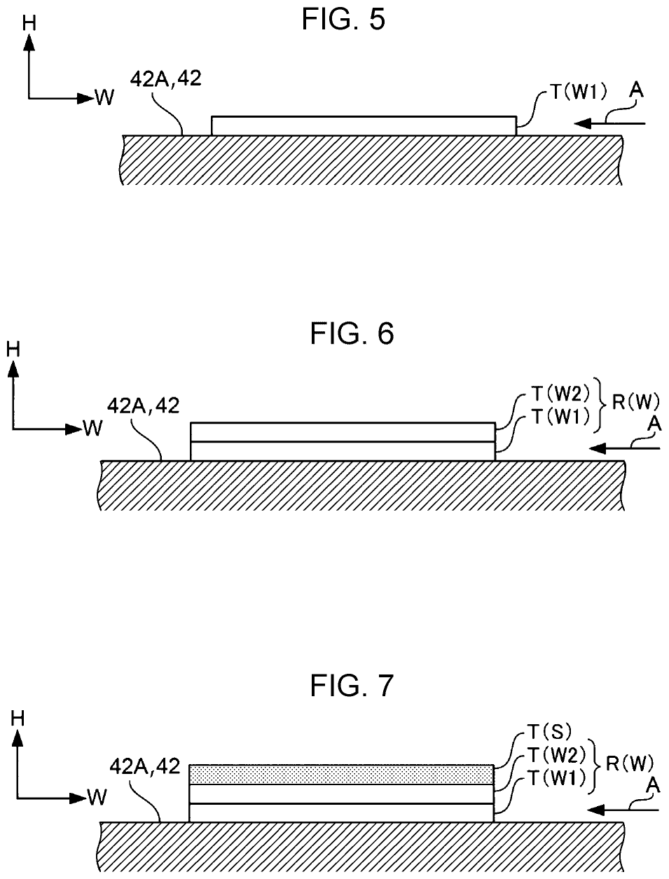

In step S204, the processor 100 performs control to form a white toner image layer R(W) on the surface 42A of the transfer belt 42. In the exemplary embodiment, as an example, the image forming unit 30(W1) forms a white toner image T(W1) of a toner density of 100% on the surface 42A of the transfer belt 42, as shown in FIG. 5. Then, the image forming unit 30(W2) superimposes a white toner image T(W2) of a toner density of 100% on the white toner image T(W1), as shown in FIG. 6. As a result, a white toner image layer R(W) is formed on the surface 42A of the transfer belt 42.

In step S206, the processor 100 performs control to superimpose a silver toner image T(S) of a toner density of 40% to 60% on the white toner image layer R(W), as shown in FIG. 7. As a result, a toner image constituted by the white toner image layer R(W) and the silver toner image T(S) superimposed on each other is formed on the surface 42A of the transfer belt 42.

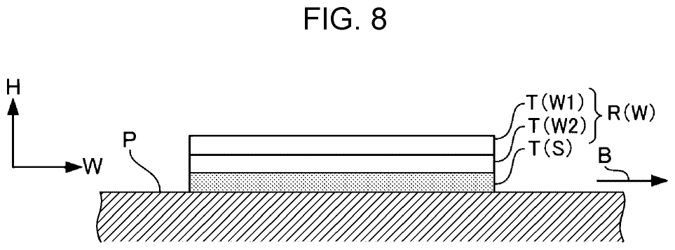

As illustrated in FIG. 8, the toner image formed on the surface 42A of the transfer belt 42 is transferred to the recording medium P by means of second transfer. Then, the fixing device 24 fixes the toner image transferred onto the recording medium P to the recording medium P.

In the image forming apparatus 20, which serves as the image forming system of the exemplary embodiment, when the color of a recording medium P is a predetermined color, the processor 100 performs control to superimpose a silver toner image T(S) on a white toner image layer R(W) formed on the surface 42A of the transfer belt 42. This may improve the opacity of the color of the recording medium P, compared with the configuration in which only a white toner image is superimposed on the surface 42A of the transfer belt 42 multiple times when the color (color information) of a recording medium P is a predetermined color. In other words, the base color, which is the color of the recording medium P, is less likely to be seen through.

In the image forming apparatus 20 of the exemplary embodiment, the processor 100 may perform control to superimpose multiple white toner images on each other so as to form a white toner image layer R(W). In this case, the opacity of the color of the recording medium P may be improved compared with the configuration in which a white toner image layer R(W) is formed by a single white toner image.

In the image forming apparatus 20 of the exemplary embodiment, the processor 100 may perform control to change the density of a white toner and that of a silver toner in accordance with the color of the recording medium P. This may improve the opacity of the color of the recording medium P compared with the configuration in which each of the density of a white toner and that of a silver toner is uniform. The amount of toner consumption may also be reduced.

In the image forming apparatus 20 of the exemplary embodiment, in accordance with the color of the recording medium P, the processor 100 may perform control to superimpose multiple white toner images of a toner density of 100% on each other to form a white toner image layer R(W) and to superimpose a silver toner image T(S) of a density of 10% to 40% on the white toner image layer R(W). This may improve the opacity of the color of the recording medium P and make the silver of the underlying layer less likely to be seen through, compared with the configuration in which the density of the silver toner is not 10% to 40%.

In the image forming apparatus 20 of the exemplary embodiment, the processor 100 may obtain information on the color of the recording medium P from the color measuring unit 110. This may allow the image forming apparatus 20 to obtain the correct color of the recording medium P compared with the configuration in which a user determines the color of the recording medium P.

In the image forming apparatus 20 of the exemplary embodiment, the processor 100 may perform control to superimpose the silver toner image T(S) on the white toner image layer R(W) when the lightness L* of the color of the recording medium P in the Lab color space satisfies L*<50. In this case, the amount of toner consumption may become smaller than the configuration in which the silver toner image T(S) is superimposed on the white toner image layer R(W) when the lightness L* of the color of the recording medium P in the Lab color space is L*>50.

In the image forming apparatus 20 of the exemplary embodiment, the processor 100 may perform control to superimpose the silver toner image T(S) on the white toner image layer R(W) when the chromaticity b* of the color of the recording medium P in the Lab color space satisfies 30>b*>−30. In this case, the amount of toner consumption may become smaller than the configuration in which the silver toner image T(S) is superimposed on the white toner image layer R(W) when the chromaticity b* of the color of the recording medium P in the Lab color space is b*<−30 or b*>30.

In the image forming apparatus 20 of the exemplary embodiment, the processor 100 may perform control to superimpose the silver toner image T(S) on the white toner image layer R(W) when the chromaticity a* of the color of the recording medium P in the Lab color space satisfies a*<−30 or a*>+30. In this case, the amount of toner consumption may become smaller than the configuration in which the silver toner image T(S) is superimposed on the white toner image layer R(W) when the chromaticity a* of the color of the recording medium P in the Lab color space is 30>a*>−30.

### Other Exemplary Embodiments

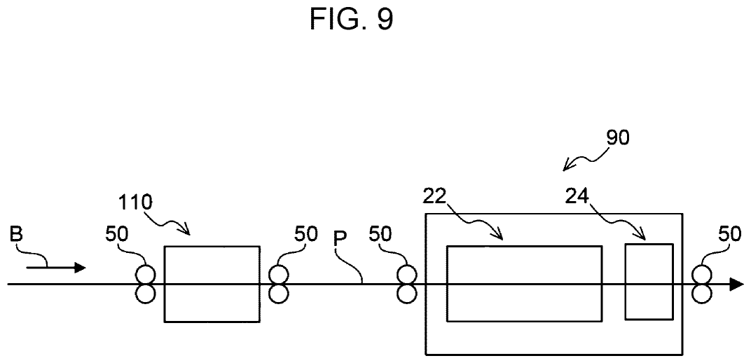

In the above-described exemplary embodiment, the color measuring unit 110 is disposed in the housing of the image forming apparatus 20. However, the disclosure is not limited to this configuration. For example, as in an image forming apparatus 90 illustrated in FIG. 9, the color measuring unit 110 may be provided in a housing different from that of the image forming apparatus 90. In this case, the color measuring unit 110 is disposed farther on the upstream side of the transport direction B of the recording medium P than the image forming apparatus 90. Color information on the color of the recording medium P measured by the color measuring unit 110 may be stored in the RAM 100C or the storage 102 via the communication unit 108, for example.

In the above-described exemplary embodiment, the image forming apparatus 20 includes the color measuring unit 110. However, the disclosure is not limited to this configuration, and the provision of the color measuring unit 110 for the image forming apparatus 20 may be omitted. In this case, a user may set color information of the recording medium P by using the operation unit 104. Color information may be set from an external source via the communication unit 108.

In the above-described exemplary embodiment, the image forming apparatus 20 includes four image forming units 30 of white, silver, and black. However, the disclosure is not limited to this configuration, and the image forming apparatus 20 may include an image forming unit 30 of another color. For example, the image forming apparatus 20 may include image forming units 30 of three colors of yellow (Y), magenta (M), and cyan (C).

The disclosure is not restricted to the above-described embodiment, and various modifications, variations, and improvements may be made without departing from the scope and the spirit of the disclosure. For example, among the above-described modified examples, some modified examples may be combined with each other in an appropriate manner.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming system comprising:
an intermediate transfer body that is used for forming a toner image on a surface of the intermediate transfer body and for transferring the toner image to a recording medium;
a white toner image former that is able to form a white toner image on the surface of the intermediate transfer body;
a silver toner image former that is disposed farther on a downstream side than the white toner image former and that is able to form a silver toner image on the surface of the intermediate transfer body; and
a processor configured to:
   perform control to superimpose a silver toner image on a white toner image layer of a white toner image formed on the surface of the intermediate transfer body when a color of the recording medium is a predetermined color.
      (((2)))

The image forming system according to (((1))), wherein:
the white toner image former includes a plurality of white toner image formers; and
the processor is configured to perform control to superimpose a plurality of the white toner images so as to form the white toner image layer.
   (((3)))

The image forming system according to (((1))) or (((2))), wherein the processor is configured to perform control to change a density of a white toner and a density of a silver toner in accordance with the color of the recording medium.

(((4)))

The image forming system according to (((2))), wherein the processor is configured to perform control to superimpose a plurality of the white toner images of a toner density of 100% on each other so as to form the white toner image layer and to superimpose the silver toner image of a toner density of 10% to 40% on the white toner image layer in accordance with the color of the recording medium.

(((5)))

The image forming system according to one of (((1))) to (((4))), further comprising:
a color measurer that measures the color of the recording medium,
wherein the processor is configured to obtain information on the color of the recording medium from the color measurer.
   (((6)))

The image forming system according to one of (((1))) to (((5))), wherein the processor is configured to perform control to superimpose the silver toner image on the white toner image layer when lightness L* of the color of the recording medium in a Lab color space satisfies L*<50.

(((7)))

The image forming system according to one of (((1))) to (((6))), wherein the processor is configured to perform control to superimpose the silver toner image on the white toner image layer when chromaticity b* of the color of the recording medium in a Lab color space satisfies 30>b*>−30.

(((8)))

The image forming system according to one of (((1))) to (((7))), wherein the processor is configured to perform control to superimpose the silver toner image on the white toner image layer when chromaticity a* of the color of the recording medium in a Lab color space satisfies a*<−30 or a*>+30.

What is claimed is:

1. An image forming system comprising:
an intermediate transfer body that is used for forming a toner image on a surface of the intermediate transfer body and for transferring the toner image to a recording medium;
a white toner image former that is able to form a white toner image on the surface of the intermediate transfer body;
a silver toner image former that is disposed farther on a downstream side than the white toner image former and that is able to form a silver toner image on the surface of the intermediate transfer body; and
a processor configured to:
perform control to superimpose a silver toner image on a white toner image layer of a white toner image formed on the surface of the intermediate transfer body when a color of the recording medium is a predetermined color.

2. The image forming system according to claim 1, wherein:
the white toner image former includes a plurality of white toner image formers; and
the processor is configured to perform control to superimpose a plurality of the white toner images so as to form the white toner image layer.

3. The image forming system according to claim 1, wherein the processor is configured to perform control to change a density of a white toner and a density of a silver toner in accordance with the color of the recording medium.

4. The image forming system according to claim 2, wherein the processor is configured to perform control to change a density of a white toner and a density of a silver toner in accordance with the color of the recording medium.

5. The image forming system according to claim 2, wherein the processor is configured to perform control to superimpose a plurality of the white toner images of a toner density of 100% on each other so as to form the white toner image layer and to superimpose the silver toner image of a toner density of 10% to 40% on the white toner image layer in accordance with the color of the recording medium.

6. The image forming system according to claim 1, further comprising:
a color measurer that measures the color of the recording medium,
wherein the processor is configured to obtain information on the color of the recording medium from the color measurer.

7. The image forming system according to claim 2, further comprising:
a color measurer that measures the color of the recording medium,
wherein the processor is configured to obtain information on the color of the recording medium from the color measurer.

8. The image forming system according to claim 1, wherein the processor is configured to perform control to superimpose the silver toner image on the white toner image layer when lightness L* of the color of the recording medium in a Lab color space satisfies L*<50.

9. The image forming system according to claim 2, wherein the processor is configured to perform control to superimpose the silver toner image on the white toner image layer when lightness L* of the color of the recording medium in a Lab color space satisfies L*<50.

10. The image forming system according to claim 1, wherein the processor is configured to perform control to superimpose the silver toner image on the white toner image layer when chromaticity b* of the color of the recording medium in a Lab color space satisfies 30>b*>−30.

11. The image forming system according to claim 2, wherein the processor is configured to perform control to superimpose the silver toner image on the white toner image layer when chromaticity b* of the color of the recording medium in a Lab color space satisfies 30>b*>−30.

12. The image forming system according to claim 1, wherein the processor is configured to perform control to superimpose the silver toner image on the white toner image layer when chromaticity a* of the color of the recording medium in a Lab color space satisfies a*<−30 or a*>+30.

13. The image forming system according to claim 2, wherein the processor is configured to perform control to superimpose the silver toner image on the white toner image layer when chromaticity a* of the color of the recording medium in a Lab color space satisfies a*<−30 or a*>+30.

14. An image forming system comprising:
intermediate transfer means for forming a toner image on a surface of the intermediate transfer means and for transferring the toner image to a recording medium;
white toner image forming means for forming a white toner image on the surface of the intermediate transfer means;
silver toner image forming means for forming a silver toner image on the surface of the intermediate transfer means, the silver toner image forming means being disposed farther on a downstream side than the white toner image forming means; and
control means for superimposing a silver toner image on a white toner image layer of a white toner image formed on the surface of the intermediate transfer means when a color of the recording medium is a predetermined color.
